(19) United States
(12) Patent Application Publication
(10) Pub. No.: US 2012/0265570 A1
(43) Pub. Date: Oct. 18, 2012

(54) METHOD FOR CRITICAL PATH SCHEDULING OF ACTIVITY TIME SEGMENTS

(76) Inventor: Tarek Mohamed Mohamed HEGAZI, Waterloo (CA)

(21) Appl. No.: 13/426,553

(22) Filed: Mar. 21, 2012

Related U.S. Application Data
(60) Provisional application No. 61/457,407, filed on Mar. 21, 2011.

(51) Int. Cl. G06Q 10/06

(52) U.S. Cl. 705/7.12

(57) ABSTRACT

A project management scheduling method applies critical path scheduling to separate the duration of each activity of the project into a group of segmented time segments attached to each other. The computer implemented method converts all activity relationships into finish-to-start between time segments without lead or lag times and corrects float and critical path calculations. Additional time segments representing daily events having either a positive or negative effect on time segment duration can be inputted and the project schedule adjusted accordingly. The method can also be employed in the conversion of existing critical path method scheduling systems.

This application claims priority from U.S. Provisional Patent Application No. 61/457,407 filed Mar. 21, 2011.

### CROSS REFERENCE TO CPS METHOD APPENDIX

All references herein to CPS, the CPS method of the present invention, and method, generally, encompass and include the detailed CPS method described in Appendix A, which is incorporated by reference in its entirety and forms part of the present disclosure.

### TECHNICAL FIELD

The present invention relates to computerized scheduling methods and in particular method for critical path scheduling of activity time segments.

### BACKGROUND OF THE INVENTION

Critical Path Method (CPM) scheduling is essential so that projects can be completed profitably and on time. Because of its benefits and the significant advancements that have been made in both computer hardware and scheduling software, the use of the CPM and its precedence diagram method (PDM) variation in all industries, including but not limited to the construction industry, has dramatically increased in the last three decades. In this specification, CPM will be used to indicate both CPM and PDM.

While the CPM calculations are simple and straightforward, CPM-based scheduling remains a challenging process. At the planning stage, the CPM network may contain complex relationships that complicate the scheduling process and introduce errors in float calculations. This difficulty adds to the perception that CPM and existing CPM systems are useful for organizational and reporting purposes, but not for decision support to reflect and react to reality.

The lack of CPM-based decision support is even more vivid once a project has started. While the schedule acts as a baseline for measuring progress, it is difficult to use it to initiate appropriate corrective actions for recovering delays and overruns. Furthermore, CPM has an important role in the analysis of the final as-built schedules in order to determine the responsibility of the different parties for any delays experienced during a project or activity. CPM schedules, however, are difficult to analyze due to many well-documented factors that impact calculation accuracy and repeatability, including but not limited to problems with multiple complex relationships among project tasks; networks with multiple relations (FF and SS) are complex to analyze and cause parts of an activity, not the whole, to be critical, which are not readily detectable; non-finish-to-start relationships with lags complicate total float determination and interpretation, potentially affecting critical path identification; SS and FF relationships use time, but not work-amount, lags; inaccurate schedule calculations; floats and the critical path can be inaccurate due to the extensive use of leads and lags; multiple calendars make it harder to analyze the critical path and floats; inaccurate dates can be produced when resource calendars are used; unrealistic activity durations can result from wrong calculations of remaining durations; difficult schedule analysis during and after execution; out-of-sequence progress (e.g., activities starting prior to completion of their predecessors) makes CPM schedules difficult to analyze; flawed schedules which are unpractical to implement; schedule analysis is not a straightforward task under multiple baseline updates; CPM is not well-suited to repetitive projects such as highways, high-rises, and multiple units (e.g., many housing units); and the lack of clear representation of site events using existing CPM-based systems makes it difficult to visualize the actions made by the various parties and accordingly analyze the project schedule.

While efforts have been put forward to improve CPM scheduling and avoid some of the calculation mistakes outlined above, for the most part the analysis is still done at an activity by activity level, which is a rough level of detail that produces calculation errors and is not suited to detailed progress analysis. The present invention aims to overcome, or alleviate, some or all of the aforementioned problems.

### SUMMARY OF THE INVENTION

The present invention introduces a novel method of project management, which introduces a scheduling method coined herein as “Critical Path Segments” (CPS), in which activity duration is not a continuous block of time, rather a group of segmented time segments attached to each other. The method of the present invention can be adapted to include innovative scheduling features such as automatic conversion of all project relations to finish-to-start, time and cost optimization, audio/visual progress recording, delay analysis, rework analysis, and visualization features. These features can help meet the time, cost, and resource constraints of single, multiple, and repetitive projects. The method of the present invention can further be adapted to provide effortless documentation of all progress events, location-based GIS features to help manage multiple projects, and can be adapted to produce extensive visual reports shown directly on 2D/3D project drawings.

The present invention describes innovative computer implemented methods (for example, connected in a wired or wireless manner by database(s) and/or web application(s)), including as follows: (i) a method for critical path analysis with separate time segments; (ii) a method and device for audio/visual progress monitoring; (iii) methods for scheduling, control, and visual reporting; and (iv) integrated optimization for large projects repetitive and scattered facilities.

In one embodiment of the present invention, there is described computer-implemented method of scheduling and tracking a project having a plurality of activities of defined duration, comprising the steps of separating the duration of each of the plurality of activities into consecutive time segments, converting a schedule relationship between two of the plurality of activities into a finish-to-start relationship without lead or lag times, using an at least one algorithm to determine the start and finish date of each of the consecutive time segments for each of the plurality of activities and the float for each of the consecutive time segments, and producing a project schedule. Additional time segments representing daily events having either a positive or negative effect on time segment duration can be inputted and the project schedule adjusted accordingly.

In another embodiment, the method of the present invention can be used on existing CPM scheduling systems using a regular CPM baseline schedule to generate a CPS schedule from the CPM baseline schedule by converting each activity into consecutive time segments and the relationships between each activity into finish-to-start relationships without lead or lag times, and using an at least one algorithm to determine the start and finish date of each of the consecutive time segments for each activity and the float for each of the consecutive time segments.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

A detailed description of the preferred embodiments is provided below by way of example only and with reference to the following drawings, in which:

FIG. 1 is depicts a sample CPS representation according to one embodiment of the present invention;

FIG. 2 is a chart showing a comparison of time-based and production-based options of the CPS method;

FIG. 3 depicts a proposed representation of activity progress determined in accordance with the CPS method;

FIG. 4 is a chart showing illustrative estimates and resource needs determined in accordance with the CPS method;

FIG. 5 is shows a representation of a formulation of key activity variables in accordance with the CPS method;

FIG. 6 is a chart depicting a representation of activity variables in accordance with the CPS method;

FIG. 7 depicts a representation of a case study illustrating: (a) activity network calculations; (b) prior art outputs of activity characterizations; and (c) activity characterizations in accordance with the CPS method;

FIG. 8 shows a series of tables (a, b, c, d) illustrating resource allocation outputs and project delay analysis in accordance with the CPS method;

FIG. 9 depicts a prior art representation of early start time activity calculations; and

FIG. 10 depicts a representation of: (a) prior art FS relationship outputs, and (b) FS relationship outputs determined in accordance with the CPS method.

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE INVENTION

All terms used herein are used in accordance with their ordinary meanings unless the context or definition clearly indicates otherwise. Also, unless indicated otherwise except within the claims the use of “or” includes “and” and vice-versa. Non-limiting terms are not to be construed as limiting unless expressly stated or the context clearly indicates otherwise (for example, “including”, “having”, “characterized by” and “comprising” typically indicate “including without limitation”). Singular forms included in the claims such as “a”, “an” and “the” include the plural reference unless expressly stated or the context clearly indicates otherwise. Further, it will be appreciated by those skilled in the art that other variations of the preferred embodiments described below may also be practiced without departing from the scope of the invention. In this detailed description, the terms “CPS” and “invention” will be used interchangeably.

As described herein, the proposed Critical Path Segments (CPS) mechanism has three principal innovative fronts: (1) representing activity duration using separate time segments (including but not limited to resource-delay time segments, progress time segments, milestone time segments, network time segments, contractor-delay time segments, owner-delay time segments, and third party event time segments); (2) providing a better representation of activity progress; and (3) providing a mechanism to incorporate project constraints into the CPS analysis. These aspects are discussed in greater detail below, followed by three examples which demonstrate that CPS offers less complex representation of activity relationships, thus leading to better identification of critical path fluctuation, and better ability to analyze schedules and mitigate delays therein.

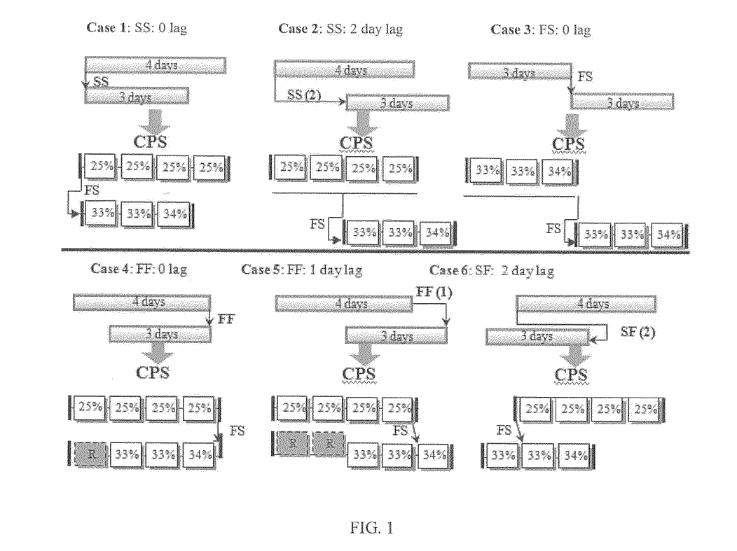

Since the representation of activities and their durations is the basis for standard schedule calculations, improving the representation of the activities would solve many of the aforementioned prior art deficiencies. Indeed, as opposed to the traditional representation of activity duration as a continuous block of time that spans the activity duration, the method of the present invention represents each activity as a number of separate consecutive time segments that add up to the total duration of the activity. For example, referring to FIG. 1, there is shown a sample CPS representation to transform relationships into (Finish-to-Start) FS with no lead or lag time. As illustrated in FIG. 1, an activity with duration of three days is represented by three time segments where each time segment is one day. This representation offers significant advantages over prior art methods as it permits direct conversion of any complex logical relationship (SS—Start-to-Start, FF—Finish-to-Finish) into a simple Finish-to-Start (FS) relationship (the three cases shown in FIG. 1), without the lag times which cause float calculation problems in traditional CPM systems. Identifying the sequence between two activities as a: (i) Start-to-Start (SS) sequence indicates that the prior activity must begin prior to the start of the following activity; (ii) Finish-to-Finish (FF) sequence indicates that the prior activity must end prior to the end of the following activity; and (iii) Finish-to-Start sequence indicates that the prior activity must be completed prior to the start of the following activity. In the ultimate FS representation, each activity is bound by start and finish milestones, as indicated by the dark solid vertical lines. For example, the SS(0) relationship is converted to a FS(0) relationship from the milestone preceding the first activity to the milestone preceding the second activity.

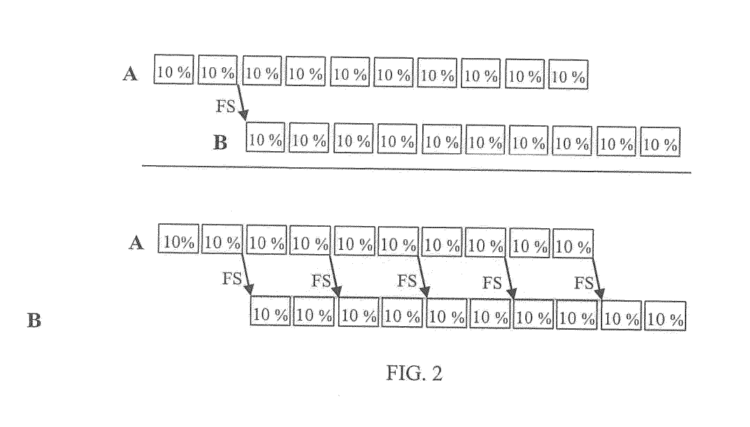

The method of the present invention provides flexible options to better represent the intent of the relationships among project activities with the project schedule, whether in the context of a linear or non-linear project, scattered subproject, or otherwise. The CPS works for both repetitive and non-repetitive activities, and can be used to define the relationship between activities not only as time-based, but also as production-based. For example, instead of indicating that steel reinforcement work can start two days after formwork begins, the CPS enables a project manager to specify, for instance, that each 20% of formwork completed is followed by 20% of steel reinforcement work. This relationship is illustrated in FIG. 2, wherein from a time-based relationship perspective, activity B starts two (2) days after the start of activity A, and wherein from a production-based relationship perspective, each 20% of work completed under activity A is followed by 20% of work under activity B. Another example of preserving the relationship intent is illustrated in cases 4 and 5 of FIG. 1 where relation segments, denoted by reference R, may need to be added.

By reporting the daily percentages of work completed on the time segments (as illustrated in FIGS. 1 and 2), it is possible to clearly convey information related to the speed with which an activity is progressing (e.g., actual vs. planned) which in turn facilitates the tracking of resources and allows more flexible resource allocation options.

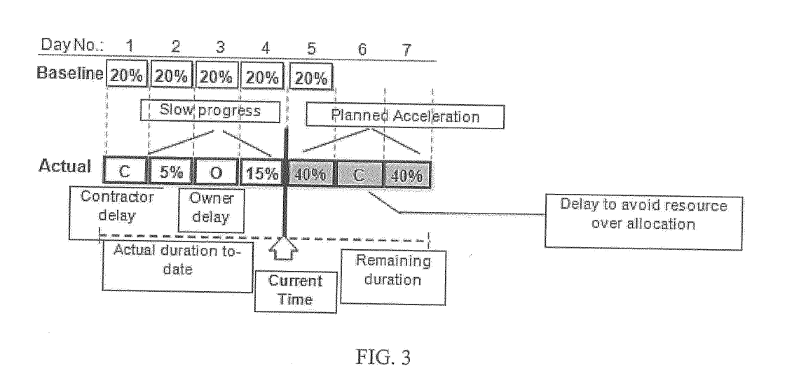

In the example depicted in FIG. 3, a project activity has a five day baseline duration or 20% expected progress per day. In this example, as the project progresses, the contractor (denoted by reference C) starts the activity (e.g., construction) one day late. After completing 5% of the activity on day two (slower than baseline of 20% per day (the “Baseline Duration”), the work was stopped on day three on account of owner (denoted by O) interruption and then resumed on day 4 with 15% contractor completion. Taken together, the contractor had completed the equivalent of only one day (or 20%) of the activity as planned. Accordingly, the contractor decided to use a faster and more expensive construction method to accelerate the activity and finish the remaining work in two days, each allocated 40%. Such a generic activity representation clearly shows the evolution of all activity events, including the effect of decisions such as acceleration and resource allocation. This representation is therefore general enough for progress recording. Accordingly, the algorithm employed under the CPS method of the present invention automatically calculates the remaining duration of each activity (the “Activity Remaining Duration”), based on the progress completed to-date (as shown on the left-side of the “actual” bar in FIG. 3).

It is noted that the remaining duration can also consider expected future events such as accelerations or delays (as shown on the right side of the “actual” bar in FIG. 3).

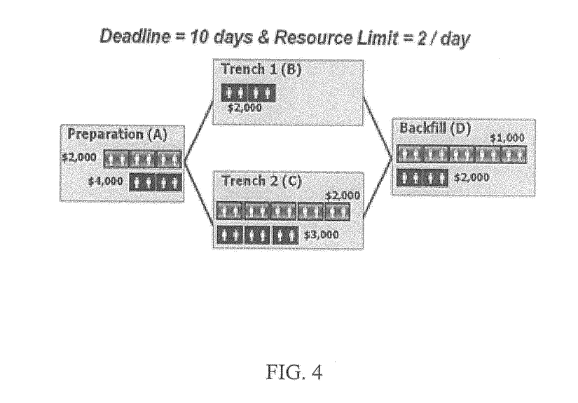

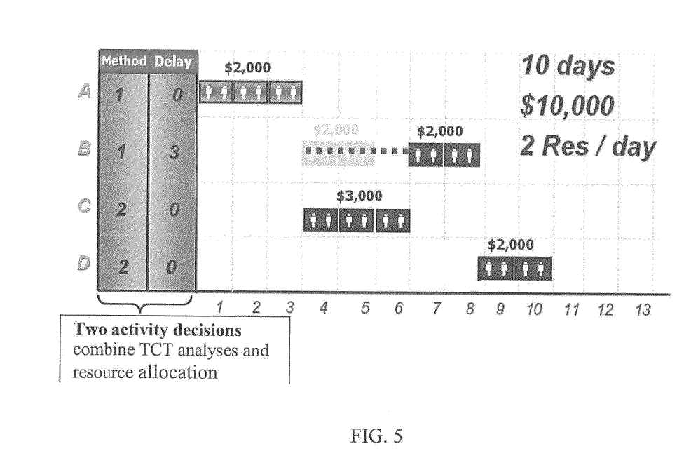

For traditional CPM networks with continuous activity durations, a simple approach to facilitate the resolution of multiple project constraints in CPS with separate time segments. To demonstrate the process, a small case study is illustrated in FIG. 4. The optional estimates for the four activities of the case study are shown in the figure, with the project having a strict 10-day deadline, a late penalty of $2,000 per day, a $100 per day indirect cost, and a strict resource limit of two personnel per day. It should be noted that the optional estimates represent practical options that vary from cheap and slow to fast and expensive. These estimates can be, for example, different subcontractor quotes, or crews with different skill levels, different equipment, or simply working overtime hours. A quick look at the project network, identified by the four activity boxes depicted in FIG. 4 reveals that activities “Trench 1” and “Trench 2” run in parallel and will require four resources (limit is two per day). In addition, using the cheapest option (estimate 1) for each activity, the project duration becomes 13 days (3 days beyond the deadline) with a total cost of $14,300 ($7,000 direct cost+$1,300 indirect cost+$6,000 penalty). To meet the deadline and resource-limit constraints, it is possible to experiment with varying decisions. Given the sequence among the activities and the various construction options, it is possible to come up with a least-expensive plan that meets both the deadline and the resource limit. The solution in FIG. 5, for example, shows a plan with a 10-day project duration, which meets the deadline, and in which all the activities are scheduled so that the resource limit is not exceeded. It is important to note that the solution in FIG. 5 shows the two quantitative decisions that need to be taken: (a) an index to the method that makes a good trade-off between the duration and cost of the activity (i.e., Time-Cost Tradeoff (TCT) analysis); and (b) the start-delay time (applies to the start of the activity) that resolves resource over-allocations by preventing many activities to run in parallel. The formulation of the key activity variables (decisions) in FIG. 5, as such, simplifies their direct incorporation into the mathematics of the CPM algorithm, not only for scheduling before construction but also for corrective actions during construction. If a project is delayed, for example, then a suitable corrective action is to decide on modified values for the two decisions (TCT method vs. delay), which will affect the remaining portion of the schedule.

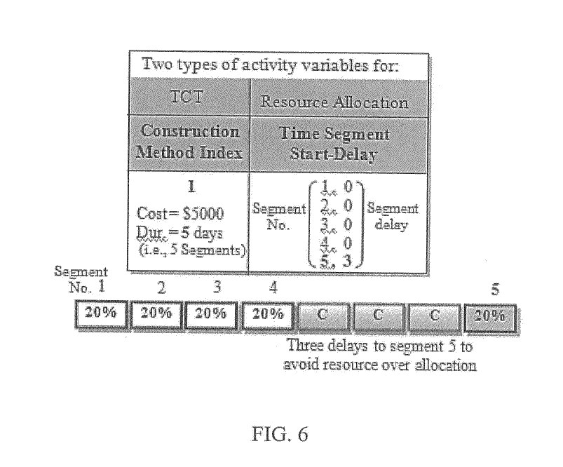

This prior art CPM approach will be even more powerful in facilitating decisions when it is reformulated using the CPS method of the present invention, wherein consideration is given to separate time segments (e.g., on-going work by the authors). As such, the CPS will allow each time segment of an activity to be independent and flexible. A generic representation of the revised project decisions in the CPS is shown in FIG. 6, where the method-index decision applies to each activity, while the start-delay decision applies to each individual time segment of the activity. As such, the CPS formulation enables resource allocation to produce more practical and realistic schedules since it will enable all individual time segments to be stopped and restarted, as necessary, so that the limited resources are not exceeded.

To demonstrate the ability of the CPS to provide better analysis than traditional CPM, three simple case studies were are used to show its ability to: (1) simplify network relationships and accurately calculate floats and the critical path (i.e. whether critical or non-critical); (2) achieve a better resource allocation and facilitate accurate delay analysis; and (3) overcome some of the problems associated with multiple calendars.

### Example 1

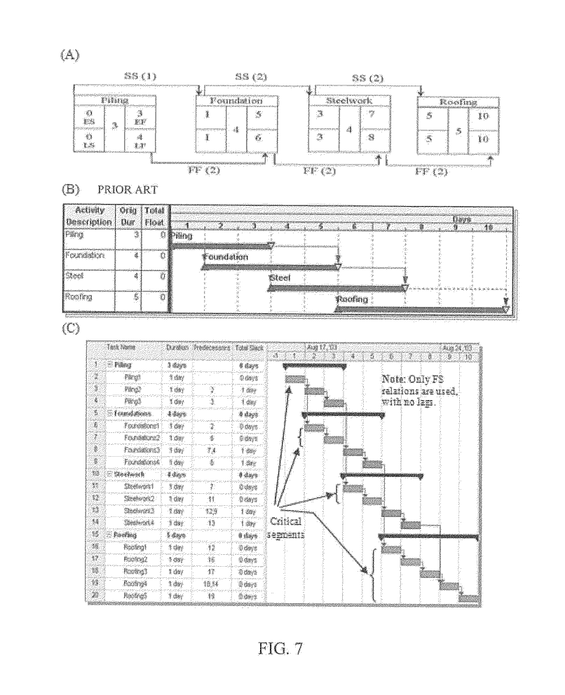

As mentioned earlier, complex relationships such as FF, SS, and SF, complicate the CPM and can lead to situations in which the activities might be partially critical. Such a situation is not detectable by available software systems mainly because of the assumption that each activity is a single undivided block of a given duration. This results in errors in the float and critical path calculations. FIG. 7 illustrates a simple case study. The figure shows a network in which each activity (e.g., piling, foundation work, steelwork and roofing) is linked by both a start-to-start (SS) and a finish-to-finish (FF) relationship. The network calculations in this case (FIG. 7(a)) reveal that the start dates are critical for all activities but, because of the overlap created by the SS and FF relationships, the finish dates for the first three activities contain float. Such a situation is complex to analyze, particularly under cases involving resource limits and/or schedule crashing, let alone progress evaluation and delay analysis. As shown in FIG. 7(b), prior art systems, which use continuous activity durations, characterize all the activities as critical.

For comparison purposes, the CPS representation has been simulated on Microsoft Project Software, with each time segment being simulated by a separate activity with a one-day duration, as shown in FIG. 7c. Although the software is not readily suited for the CPS representation, FIG. 7c clearly shows that only the first two days of activities B and C are critical, not the whole activity. FIG. 7c also shows that the CPS used only FS relationships with zero lag times. As such, Case 1 clearly illustrates the ability of the CPS to simplify network representation and accurately calculate the floats and the critical path.

### Example 2

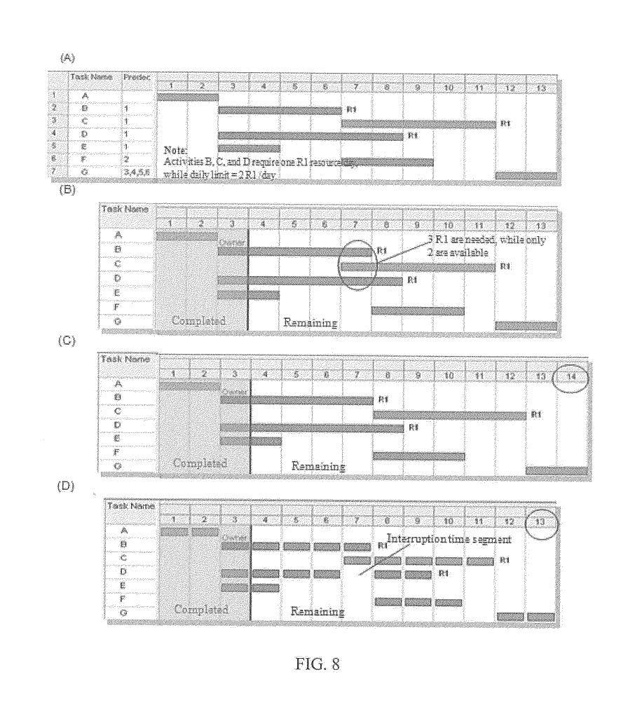

In Example 2, a small project is considered and is intended to show that CPS is more flexible in terms of resource allocation and allows detailed schedule analysis of project delays. FIG. 8a shows the as-planned schedule of a seven-activity project, with activities B, C, and D, each requiring one R1 resource (limit=2 R1/day). The 13-day as-planned schedule of FIG. 8a, therefore, meets the resource limit.

During the course of construction, the owner caused a delay in activity B on day 3 (FIG. 8b). Although the delay did not affect the critical path, it made the initial resource allocation for the remaining work impractical on day 8 (FIG. 8b). To resolve this resource over allocation, the contractor would be forced to delay the project one day (FIG. 8c) to become 14 days. Accordingly, regular schedule analysis would indicate that the contractor may claim a one-day extension due to the resource over-allocation resulting from the owner delay.

Using the CPS approach, the resource leveling solution for this case results in a 13-day schedule, thus causing no project extension (FIG. 8d). The solution was achieved by having a one time segment delay inserted before the fifth time segment of the activity D. It is important to note that although existing software systems includes an option for splitting the activities during the resource-leveling process, it does not permit activities that have been already started to be split. Since the CPS does not suffer from this limitation, it offers more flexible resource leveling solutions, particularly for project updates and corrective action plans. The result of this case illustrates the flexibility of the CPS in resource leveling and schedule analysis.

### Example 3

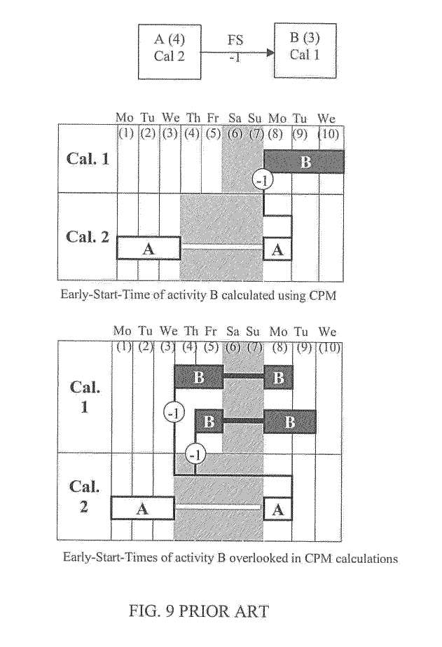

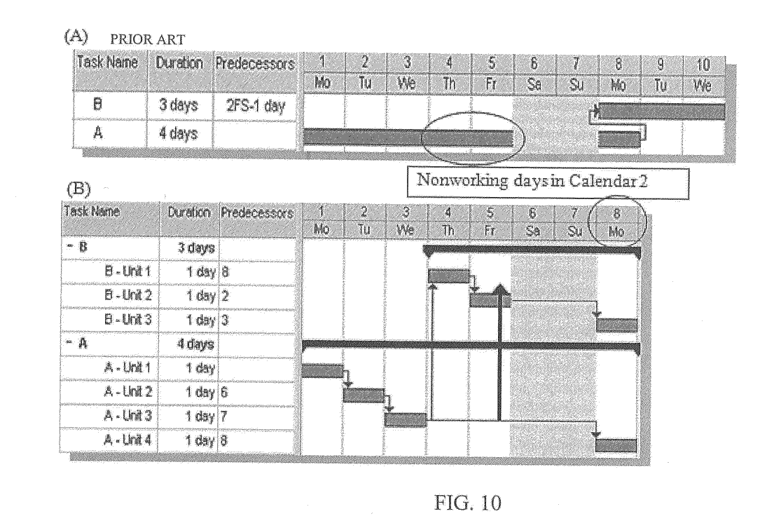

In Example 3, a small project involving the use of multiple calendars is used. As shown in the top part of FIG. 9 (prior art), activities A and B have a Finish-to-Start (FS) relationship with (−1) lag. Accordingly, forward pass calculation in CPM determines that the early start time (EST) of B is Day 8. However, since the FS relationship with −1 lag means that the successor can start whenever the remaining duration of the predecessor is 1 day, other options exist for the EST of activity B. Because of the difference in the calendars, the bottom part of FIG. 9 shows that activity B can start either on day 4 or day 5. As such, day 4 is the EST of activity B, not day 8, which is not detectable by CPM calculations and existing software systems. Prior art systems specify day 8 as the EST of activity (or task name) B (illustrated in FIG. 10(a) (prior art)), without taking advantage of the other possible EST times for activity B. It is noted that because existing systems display only one calendar on the bar chart, FIG. 10(a) wrongly shows that activity A extends over the nonworking days of Calendar 2 (Thursday and Friday), which does not give a correct indication of the activity duration.

Using the CPS method, Example 3 was simulated using separate activities as shown in FIG. 10(b). The FS (−1) relationship was converted into a simple FS between the end of segment 3 of activity A and the start of segment 1 of Activity B, without lag (relationship is highlighted on FIG. 10b). The figure clearly shows that no work will be performed for activity A on its nonworking days. More importantly, it illustrates how the CPS is capable of taking advantage of possible earlier times to finish the project in 8 days, rather than 10.

As shown in the above examples, the steps followed to employ the CPS approach using existing CPM scheduling systems include the following: (i) Generating a regular CPM baseline schedule; (ii) Generating a CPS schedule from the CPM baseline schedule by converting each activity into time segments and the relationships between each activity into FS relationships, using the method of the present invention; (iii) Using the CPS schedule to calculate the float for each time segment of each activity; and (iv) Inserting additional time segments to represent daily events having either a positive or negative effect on time segment duration (e.g., progress, delays, etc.) and adjusting the CPS schedule accordingly.

Based on the results of the three examples described above, the system of the present invention is demonstrated to markedly improve the project scheduling process. One of the benefits of using the CPS in background computations of a schedule is that it offers little changes to the manner by which scheduling basics are taught. The method of the present invention represents a detailed scheduling technique that is advantageous for documenting and analyzing as-built schedules. The method provides enhanced granularity of project scheduling which in turn enables efficient project control through better recording of site events, resource management, delay analysis, and corrective actions.

What is claimed is:

1. A computer-implemented method of scheduling and tracking a project having a plurality of activities of defined duration, comprising the steps of:
separating the duration of each of the plurality of activities into consecutive time segments;
converting a schedule relationship between two of the plurality of activities into a finish-to-start relationship without lead or lag times; and
using an at least one algorithm to determine the start and finish date of each of the consecutive time segments for each of the plurality of activities, and calculate the float for each of the consecutive time segments.

2. The method of claim 1 further comprising the step of using the at least one algorithm to determine critical and non-critical time segments.

3. The method of claim 1 further comprising the step of using the at least one algorithm to produce a project schedule.

4. The method of claim 1, wherein each of the plurality of activities is repetitive or non-repetitive.

5. The method of claim 1, wherein the schedule relationship is one of start-to-start, finish-to-finish, and start-to-finish.

6. The method of claim 1, wherein the project is selected from a linear or non-linear project, or scattered subproject.

7. The method of claim 1, wherein each of the consecutive time segments is selected from the group consisting of resource-delay time segments, progress time segments, milestone time segments, network time segments, contractor-delay time segments, owner-delay time segments, and third party event time segments.

8. A computer-implemented method of scheduling and tracking a project having a plurality of activities of defined duration, comprising the steps of:
generating a critical path method baseline project schedule;
separating the duration of each of the plurality of activities from the baseline schedule into consecutive time segments;
converting a schedule relationship between two of the plurality of activities into a finish-start relationship without lead or lag times; and
using an at least one algorithm to determine the start and finish date of each of the consecutive time segments for each of the plurality of activities, and calculate the float for each of the consecutive time segments.

9. The method of claim 8 further comprising the step of using the at least one algorithm to determine critical and non-critical time segments.

10. The method of claim 8 further comprising the step of using the at least one algorithm to produce a project schedule.

11. The method of claim 8, wherein each of the plurality of activities is repetitive or non-repetitive.

12. The method of claim 8, wherein the schedule relationship is one of start-to-start, finish-to-finish, and start-to-finish.

13. The method of claim 8, wherein the project is selected from a linear or non-linear project, or scattered subproject.

14. The method of claim 8, wherein each of the consecutive time segments is selected from the group consisting of resource-delay time segments, progress time segments, milestone time segments, network time segments, contractor-delay time segments, owner-delay time segments, and third party event time segments.
